(19) United States
(12) Patent Application Publication
(10) Pub. No.: US 2024/0429462 A1
(43) Pub. Date: Dec. 26, 2024

(54) OPTICAL LIQUID DETECTION SYSTEM

(71) Applicant: Lisa Dräxlmaier GmbH, Vilsbiburg (DE)

(72) Inventor: Grzegorz WOJCIK, Zabrze (PL)

(73) Assignee: Lisa Dräxlmaier GmbH, Vilsbiburg (DE)

(21) Appl. No.: 18/828,848

(22) Filed: Sep. 9, 2024

Related U.S. Application Data
(63) Continuation of application No. PCT/EP2023/054991, filed on Feb. 28, 2023.

(30) Foreign Application Priority Data
Mar. 9, 2022 (GB) 2203308.8

(51) Int. Cl. H01M 10/42; B60L 3/00; B60L 58/10; G01M 3/04; H01M 10/6567; H01M 50/249

(52) U.S. Cl. CPC H01M 10/4228; G01M 3/047; H01M 10/425; H01M 10/6567; H01M 50/249; B60L 3/0046; B60L 58/10

(57) ABSTRACT

An optical liquid detection system for detecting liquid intrusion and/or liquid leakage inside a battery pack of an electrical vehicle includes: at least one optical refractive index sensor that includes a polymer optical fiber cable that includes an optical input, an optical output and at least one optical sensing region; an optical transmitter providing an optical signal at the optical input of the polymer optical fiber cable; and an optical receiver for receiving the response of the optical signal at the optical output of the polymer optical fiber cable. The at least one optical refractive index sensor outputs a response of the optical signal at the optical output of the polymer optical fiber cable based on a refraction index of a fluid covering at least partly the at least one optical sensing region. The response is indicative of a liquid intrusion and/or liquid leakage inside the battery pack

### CROSS-REFERENCE TO RELATED APPLICATIONS

This application is a continuation of International Application No. PCT/EP2023/054991, filed on Feb. 28, 2023, which claims priority to and the benefit of GB 2203308.8 filed on Mar. 9, 2022. The disclosures of the above applications are incorporated herein by reference.

### FIELD

The present disclosure relates to an optical liquid detection system and a corresponding method for detecting liquid intrusion and/or liquid leakage inside a battery pack of an electrical vehicle.

### BACKGROUND

The statements in this section merely provide background information related to the present disclosure and may not constitute prior art.

Many electric vehicles (EVs) are equipped with hermetically sealed battery packs, which tend to have different cooling strategies (passive or active). Due to a desire to increase power of the battery packs, the battery thermal management systems become more sophisticated and technologies such as immersive cooling (i.e. based on partially or fully submerged battery cells) are applied. If a liquid leakage (e.g., coolant) or foreign liquid intrusion (e.g., water) were to occur in the vehicle energy storage systems (i.e., battery packs), they could create unintended conditions. For lithium-ion battery packs, this could result in short-circuit or accelerated degradation. If not detected properly, a cascade of events can occur that may lead to a thermal runaway, that is, uncontrolled rise of temperature, which may lead to pressure build-up, and release of gases.

Currently, EV battery packs are mainly equipped with electrical liquid presence sensors (resistive). These electrical sensors are susceptible to environment conditions and ageing and are galvanically isolated. Besides, due to electrolysis of liquid and sensor, electrical sensors are not suggested to be used for a longer time than about one hour in liquid. These are disadvantages that decrease robustness of this solution and potentially increase maintenance cost over the car's lifespan. Furthermore, electrical sensors are susceptible to electromagnetic interference (EMI). When there is a significant change of current drawn from the battery, e.g., during car's acceleration or deceleration, the electromagnetic field is generated and coupled with other components (ECU's). This results in electrical noise to the information-carrying signals, e.g., of electrical sensors.

### SUMMARY

This section provides a general summary of the disclosure and is not a comprehensive disclosure of its full scope or all of its features.

The present disclosure provides a liquid detection system for use in an electric vehicle that is able to reliably detect liquid intrusion and liquid leakage.

The present disclosure provides a liquid detection system for use in an EV's battery pack.

A basic idea of this disclosure is to apply electronics and one or more optical sensors, in particular, evanescent wave absorption polymer optical fiber sensors, that are distributed among the vehicle energy-storage system to measure the refractive index. Refractive index monitoring is used for distinguishing the difference between the fluid that the sensor is submerged in. This technique allows to monitor for coolant leakage, e.g., mineral oil, foreign liquid intrusion, e.g., water, or even coolant ageing and improves the safety of the vehicle energy-storage systems and electric vehicles in general.

The liquid detection system presented in this disclosure is based on optical sensors which are not susceptible to high voltages inside battery pack, nor ESD (electrostatic discharge) or EMI (electromagnetic interference). The liquid detection system may improve the safety of EV battery packs by detecting faults, such as oil leakage and water intrusion which may result in battery accelerated degradation or thermal runaway.

The disclosed liquid detection system uses optical sensors which are not susceptible to corrosion and may be safer when placed in high voltage area such as vehicle energy storage systems of e.g., 400V or 800V. The electronics can be placed in a low-voltage area, e.g., together with the battery management system (BMS) as the sensors are made of polymer optical fibers which can be several meters long. The sensor itself is not susceptible to electromagnetic interference. The liquid detection system can be produced either as a dedicated module for automotive batteries or as a part of the battery management system.

In order to describe the present disclosure in detail, the following terms, abbreviations and notations will be used:
EV electric vehicle
ECU electronic control unit
EMI electromagnetic interference
POF polymer (or plastic) optical fiber (cable)
RI refractive index

An electric vehicle (EV) according to this disclosure is a vehicle that uses one or more electric motors or traction motors for propulsion. An electric vehicle may be powered through a collector system by electricity from off-vehicle sources, or may be self-contained with a battery, solar panels, fuel cells or an electric generator to convert fuel to electricity. EVs include, but are not limited to, road and rail vehicles, surface and underwater vessels, electric aircraft and electric spacecraft.

An electronic control unit (ECU) according to this disclosure is an embedded system in automotive electronics that controls one or more of the electrical systems or subsystems in a vehicle. Types of ECU include engine control module (ECM), powertrain control module (PCM), Transmission Control Module (TCM), Brake Control Module (BCM), Central Control Module (CCM), etc.

In this disclosure, battery cells, battery modules and battery packs are described.

Battery cells are low voltage, each cell has a specific voltage range, e.g. for lithium ion chemistry the operating voltage range is 3.0V-4.2V.

Battery modules are made of many cells connected in series (to increase total voltage), and parallel (to increase total capacity). Battery modules are commonly designed to meet low voltage specification (e.g. according to ISO6469), so they can be manufactured and handled without additional precautions.

Battery pack is made of many battery modules, connected in series and/or in parallel as well. A battery pack's area is high voltage. Battery packs include not only of battery cells and modules, but electronics, switch-box, heat management systems as well.

According to a first aspect, the disclosure relates to an optical liquid detection system for detecting liquid intrusion and/or liquid leakage inside a battery pack of an electrical vehicle, the optical liquid detection system comprising: at least one optical refractive index sensor comprising a polymer optical fiber cable, the polymer optical fiber cable comprising an optical input, an optical output and at least one optical sensing region; at least one optical transmitter connected to the polymer optical fiber cable of a respective optical refractive index sensor for providing an optical signal at the optical input of the polymer optical fiber cable; wherein the at least one optical refractive index sensor is configured to output a response of the optical signal at the optical output of the polymer optical fiber cable based on a refraction index of a fluid covering at least partly the at least one optical sensing region, the response being indicative of a liquid intrusion and/or liquid leakage inside the battery pack; and at least one optical receiver connected to the polymer optical fiber cable of the respective optical refractive index sensor for receiving the response of the optical signal at the optical output of the polymer optical fiber cable.

Such an optical liquid detection system provides a robust and reliable detection of liquid intrusion and liquid leakage for use in an EV's battery pack.

Such optical liquid detection system is based on optical sensors which are not susceptible to high voltages inside battery pack, nor ESD or EMI. The optical liquid detection system may improve the safety of EV battery packs by detecting faults, such as oil leakage and water intrusion which may result in battery accelerated degradation or thermal runaway.

In an exemplary form of the optical liquid detection system, the response can be further indicative of a faultless condition in which there is no liquid intrusion or liquid leakage inside the battery pack.

This provides the advantage that the optical liquid detection system can also monitor a normal situation in which no fault occurs and the user is informed that there is no fault, i.e., no liquid intrusion or liquid leakage inside the battery pack.

In an exemplary form of the optical liquid detection system, the at least one optical refractive index sensor is configured to output the response of the optical signal based on an evanescent wave absorption of the optical signal in the at least one optical sensing region.

This provides the advantage that using evanescent wave absorption of the optical signal allows to differentiate between different media with a high precision. Hence, faults with respect to liquid leakage or intrusion can be reliably detected.

In an exemplary form of the optical liquid detection system, the polymer optical fiber cable of the at least one optical refractive index sensor comprises a fiber core and a cladding covering the fiber core, wherein the cladding is at least partially removed in the at least one optical sensing region.

This provides the advantage that the POF cable can be flexible used to monitor a variety of different places in the battery pack due to multiple optical sensing regions. The POF cable can be deposited within the cooling medium inside the battery pack without being susceptible to sensor degradation caused, e.g., by electrolysis.

POF cables can, for example, have the following structure: A non-automotive POF cable can have a core, a cladding and an outer jacket. An automotive POF cable can have a core, a cladding, an inner jacket and an outer jacket. The most important layers for this disclosure are core and cladding. Jackets may be used for additional mechanical and thermal protection.

In an exemplary form of the optical liquid detection system, the optical transmitter comprises an electrical-to-optical signal converter, in particular a light emitting diode, for providing the optical signal; and the optical receiver comprises an optical-to-electrical signal converter, in particular a photodiode, for converting the response of the optical signal into an electrical signal.

This provides the advantage that an optical signal can be utilized for liquid leakage/intrusion detection. This optical signal is not sensitive to the high voltages of the battery cells/modules inside the battery pack and does not result in harmful EMV or ESD effects.

In an exemplary form of the optical liquid detection system, the optical liquid detection system comprises an electronics circuit configured to provide an electrical current to the optical transmitter for generating the optical signal, wherein the electronics circuit is configured to process the electrical signal corresponding to the response of the optical signal.

This provides the advantage that the optical signal and the response signal of the optical signal can be efficiently processed in the electrical domain which can be located in a safe distance from the battery cells/modules or can be implemented by the BMS controller.

In an exemplary form of the optical liquid detection system, the electronics circuit comprises a microcontroller configured to determine a refractive index of the fluid based on the electrical signal.

This provides the advantage that the microcontroller can be used for efficiently processing different algorithms for determining the refractive index.

In an exemplary form of the optical liquid detection system, the microcontroller is configured to determine a liquid intrusion and/or a liquid leakage inside the battery pack based on the refractive index of the fluid.

This provides the advantage that the microcontroller can efficiently determine such events by using signal processing algorithms.

In an exemplary form of the optical liquid detection system, the microcontroller is configured to monitor the refractive index of the fluid and to detect a liquid intrusion and/or a liquid leakage based on a deviation of the refractive index from a threshold.

This provides the advantage that the microcontroller can efficiently monitor liquid intrusion/leakage by comparing the refractive index with a known threshold, e.g. a refractive index of a coolant.

In an exemplary form of the optical liquid detection system, the threshold corresponds to a refractive index of a coolant inside the battery pack.

This provides the advantage that the threshold can be preprocessed and is known.

In an exemplary form of the optical liquid detection system, the microcontroller is configured to monitor the refractive index of the fluid and to detect a liquid intrusion and/or a liquid leakage based on a predetermined model of the battery pack and/or a statistic characteristic of the refractive index.

This provides the advantage that the detection can be flexible adapted to the respective battery model of the vehicle or can be based on statistics, e.g. average values, standard deviation, median, etc.

Additional advantage of a predetermined model is that the predetermined model will also take into account external factors which influence sensor readings (such as ambient temperature) to minimize false alarms (liquid intrusion/leakage) reported by the system.

In an exemplary form of the optical liquid detection system, the microcontroller is configured to detect a coolant leakage, a foreign liquid intrusion and/or a coolant ageing based on a monitoring of the refractive index over time.

This provides the advantage that the kind of fault determined by the liquid detection system can be signaled to the user of the car. The user can decide based on this information whether to change or repair the battery pack.

In an exemplary form of the optical liquid detection system, the electronics circuit comprises a first connector for mechanically and optically connecting the optical transmitter, wherein a light emitting diode is embedded in the first connector; and a second connector for mechanically and optically connecting the optical receiver, wherein a photodiode is embedded in the second connector.

This provides the advantage of easy and fast production of both connectors.

In an exemplary form of the optical liquid detection system, the first connector may be embedded in a first plastic housing and the second connector may be embedded in a second plastic housing; or alternatively, the first connector and the second connector may be embedded in a common plastic housing.

This provides the advantage that the optical refractive index sensor can be robust attached to the electronics circuit. The plastic housing allows to easily change an optical transmitter or optical receiver in case of a malfunction.

In an exemplary form of the optical liquid detection system, the at least one optical sensing region may be placed, for example, at a top surface or a bottom surface inside a housing of the battery pack. It should be understood that this is only an example for placing the optical sensing regions. Other places in the battery pack may be applied as well.

This provides the advantage that at the top surface, a liquid leakage can be efficiently detected and at the bottom surface, a liquid intrusion can be efficiently detected, in particular for intrusion of liquids of different densities (e.g., oil<water, then water will fall to the bottom surface).

According to a second aspect, the disclosure relates to a battery pack of an electrical vehicle, the battery pack comprising: a housing for housing at least one battery module and a coolant, the at least one battery module being immersed within the coolant; and an optical liquid detection system according to the first aspect, mounted inside the housing, wherein the optical liquid detection system is configured to detect foreign liquid intrusion, leakage of the coolant and/or ageing of the coolant.

Such a battery pack with optical liquid detection system provides a robust and reliable detection of liquid intrusion and liquid leakage for use in an electric vehicle.

According to a third aspect, the disclosure relates to a method for detecting liquid intrusion and/or liquid leakage inside a battery pack of an electrical vehicle, by at least one optical refractive index sensor comprising a polymer optical fiber cable, the polymer optical fiber cable comprising an optical input, an optical output and at least one optical sensing region, the method comprising: providing an optical signal at the optical input of the polymer optical fiber cable; outputting, by the at least one optical refractive index sensor, a response of the optical signal at the optical output of the polymer optical fiber cable based on a refraction index of a fluid covering at least partly the at least one optical sensing region, the response being indicative of a liquid intrusion and/or liquid leakage inside the battery pack; and receiving the response of the optical signal at the optical output of the polymer optical fiber cable.

Such a method provides an efficient mechanism for detecting liquid intrusion or liquid leakage. The method may use optical sensors which are not susceptible to high voltages inside battery pack, nor ESD or EMI. Such method improves the safety of EV battery packs by detecting faults, such as oil leakage and water intrusion which may result in battery accelerated degradation or even thermal runaway.

In an exemplary form of the method, the method may comprise a postprocessing of the response of the optical signal based on external factors, in particular an ambient temperature, in order to reduce false-alarms and diagnosis faults.

As mentioned, this provides the technical advantage of a very robust sensing method with reduced false-alarms and diagnosis issues.

According to a fourth aspect, the disclosure relates to a computer program product including computer executable code or computer executable instructions that, when executed, causes at least one computer to execute the method according to the third aspect. Such a computer program product may include a non-transient readable storage medium storing program code thereon for use by a processor, the program code comprising instructions for performing the method as described above.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a simplified block diagram illustrating a battery pack of an electric vehicle including an optical liquid detection system according to the present disclosure;

FIG. 2 is a block diagram of the optical liquid detection system according to the present disclosure including an electronics section and a sensor section;

FIG. 3 is a block diagram of the electronics section of the optical liquid detection system shown in FIG. 2 according to an example of the present disclosure;

FIG. 4 is a block diagram of the sensor section of the optical liquid detection system shown in FIG. 2 according to an example of the present disclosure;

FIG. 5A is a schematic diagram illustrating an optical refractive index sensor according to an example of the present disclosure;

FIG. 5B is a schematic diagram illustrating an optical refractive index sensor according to FIG. 5A of the present disclosure;

FIG. 6 is a schematic diagram illustrating a method for detecting liquid intrusion and/or liquid leakage inside a battery pack of an electrical vehicle according to the present disclosure;

FIG. 7 is an example signal diagram illustrating a water intrusion fault detected by the optical liquid detection system according to the present disclosure;

FIG. 8 is an example signal diagram illustrating an oil leakage fault detected by the optical liquid detection system according to the present disclosure;

FIG. 9 is an example signal diagram in a normalized representation illustrating the water intrusion fault of FIG. 7; and

FIG. 10 is an example signal diagram in a normalized representation illustrating the oil leakage fault of FIG. 8.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that comments made in connection with a described method may also hold true for a corresponding device or system configured to perform the method and vice versa. Further, it is understood that the features of the various exemplary aspects described herein may be combined with each other, unless specifically noted otherwise.

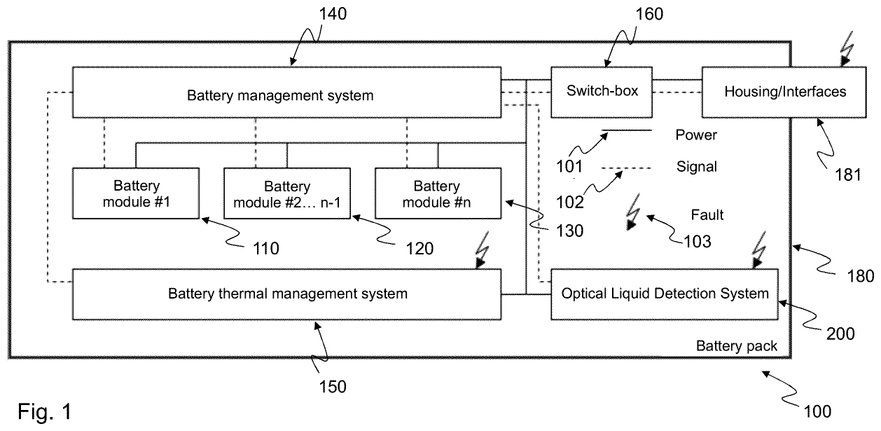

FIG. 1 shows a simplified block diagram illustrating a battery pack 100 of an electric vehicle including an optical liquid detection system 200 according to the disclosure. The battery pack 100 comprises beside the optical liquid detection system 200 a plurality of battery modules 110, 120, 130, a battery management system (BMS) 140, a battery thermal management system 150, a switch-box 160 and housing interfaces 181. These components shown in FIG. 1 may be placed inside a housing 180 of the battery pack 100, also denoted as “battery pack tray” and embedded within a coolant inside the housing 180.

The BMS 140 can control the above-described components of the battery pack 100 via signaling lines 102.

The power can be provided by battery modules (i.e., cells inside the modules). The modules can supply power to every other component. If the battery pack is OK (no fault is detected such as short-circuit, under voltage, liquid intrusion or other) then the power can be delivered to the rest of the car via battery pack interfaces 181. In case of any fault, the switch-box 160 will turn off the power supply 101 delivered to the car. But the BMS 140 and other battery pack components will remain powered, even with a failure present.

The BMS 140 comprises a microprocessor. This microprocessor may be independent of, or integral to, the vehicle management system. The BMS controller also includes memory for storing data and processor instructions, with the memory being comprised of EPROM, EEPROM, flash memory, RAM, solid state drive, hard disk drive, or any other type of memory or combination of memory types. In the context of this disclosure, the BMS controller may be responsible for battery fault diagnosis (model-based or non-model based), in particular the liquid intrusion and liquid leakage, based on data provided by POF refractive index sensors as described in this disclosure.

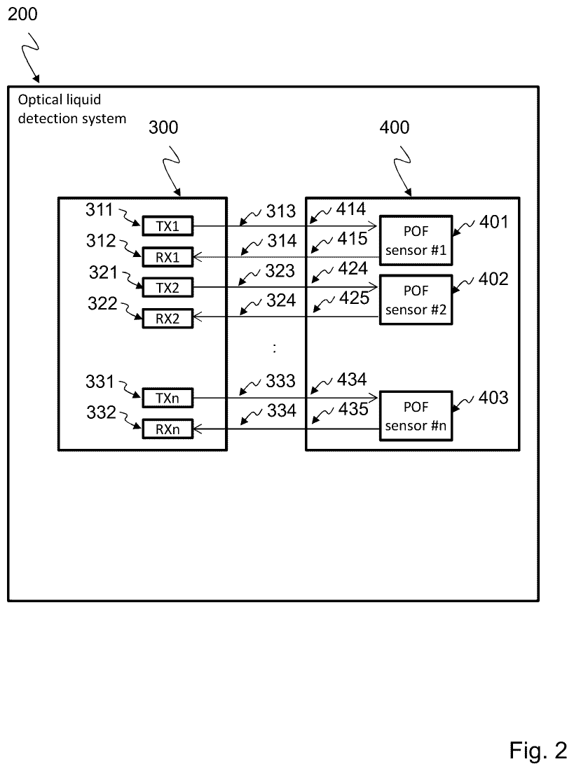

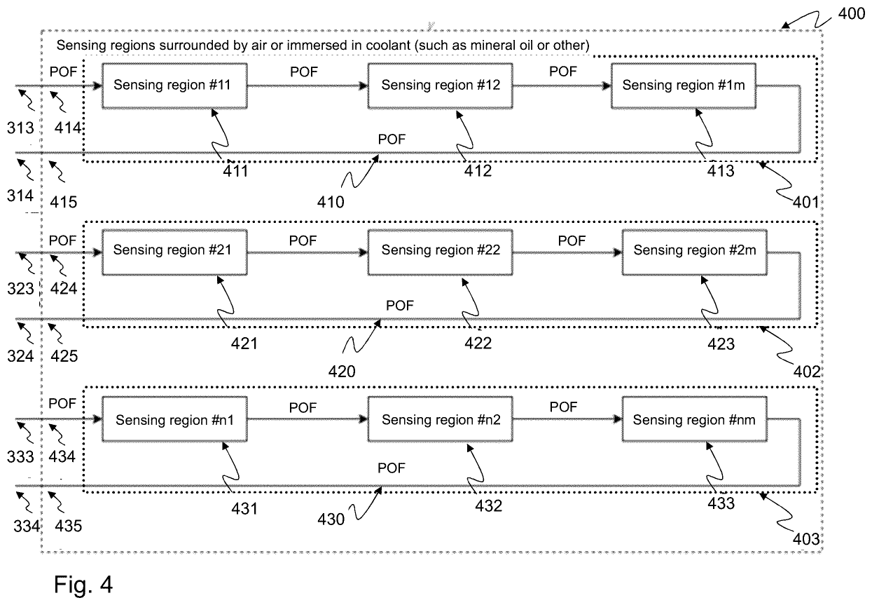

The BMS 140 of the battery pack 100 or a dedicated ECU can monitor liquid intrusion and the liquid leakage faults that may occur to the battery pack 100, using plastic optical fiber (POF) refractive index (RI) sensors as described below with respect to FIGS. 2, 4 5A and 5B.

POF RI sensors (such as evanescent wave absorption polymer optical fiber sensors) can be distributed among the vehicle energy-storage system, i.e., the battery pack 100.

Based on the sensor measurements and appropriate postprocessing algorithms, e.g., model based or non-model based diagnosis, the optical liquid detection system 200 is able to detect faults such as liquid intrusion or liquid leakage.

In FIG. 1, the optical liquid detection system 200 is illustrated as a single block. However, parts of the functionality of the optical liquid detection system 200, in particular of the electronics, can be implemented in the BMS 140 or on a separate ECU (not shown in FIG. 1).

The optical liquid detection system 200 utilizes electronics components and one or more refractive index polymer optical fiber sensors, e.g., evanescent wave absorption polymer optical fiber sensors, distributed among the vehicle energy-storage system to monitor abnormalities occurring to the measurement.

Refractive index monitoring is used for distinguishing the difference between the fluid that the sensor(s) is (are) immersed in. This method allows to monitor the following events: 1) coolant leakage (e.g., mineral oil), 2) foreign liquid intrusion (e.g. water), 3) or even coolant ageing (its RI can change over lifetime, depending on the used coolant) and improves the safety of vehicle energy-storage systems and electric vehicles in general.

The optical liquid detection system 200 can detect liquid leakage and liquid intrusion for vehicle energy-storage systems. This can be useful for battery packs in general, but especially for battery packs with partially or fully submerged battery cells as shown in FIG. 1.

Liquid intrusion or leakage can create dangerous conditions, which could finally result in a dangerous thermal runaway. It is a consequence of cascaded events and failure propagation, which may be initially caused by failures such as lithium-ion cell short circuit caused e.g. by water intrusion or cell overheating, caused by the coolant leakage, and leading to the accelerated degradation. The thermal runaway is one of the most severe lithium-ion battery fault. This exothermic reaction may result in release of large amounts of heat and flammable gases.

The optical liquid detection system 200, as will be described in more detail below with respect to FIGS. 2 to 4, utilizes electronics components, such as microcontroller, operational amplifier, LEDs, photodiodes, to convert electrical signals into optical signals, and vice-versa, and to communicate with other systems such as battery management system (BMS) 140. One or more polymer optical fiber sensors are connected to the POF connectors (receivers and transmitters) as shown in FIGS. 2 to 4, to monitor areas distributed among the battery pack 100, where the liquid leakage or liquid intrusion is most likely to occur.

Optical sensors as disclosed herein can be made of polymer optical fibers in such way, that a small portion, e.g., 20 mm of the fiber is morphologically modified, i.e., outer jacket removed and a polished core-cladding structure, to achieve the evanescent wave absorption POF sensors. Such sensors are capable of measuring the refractive index of fluid that they are submerged in. The techniques described in this disclosure can detect the aforementioned faults 103 based on refractive index. Some of the refractive indices are for example: air=1.00 nD, water=1.33 nD, mineral oil=1.44 nD.

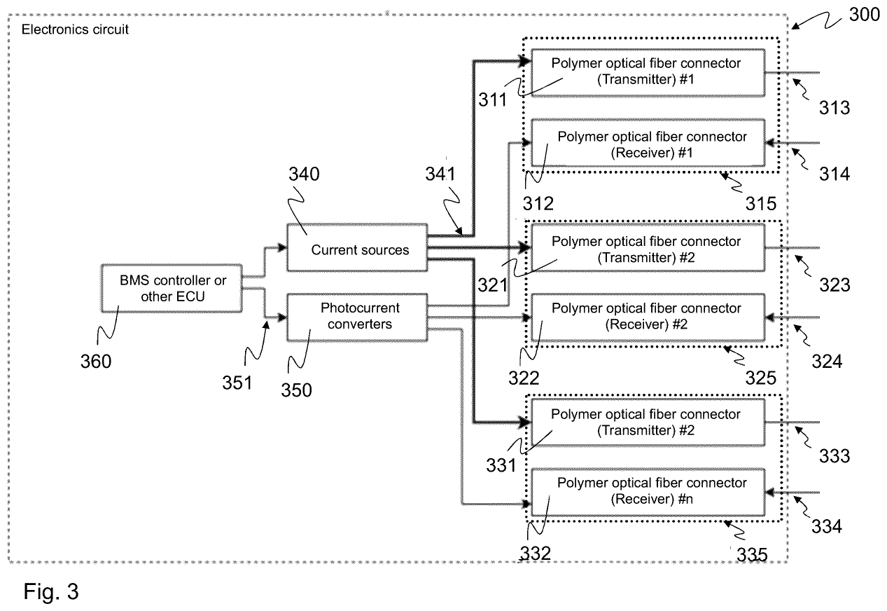

FIG. 2 shows a block diagram of the optical liquid detection system 200 according to the disclosure including electronics section or circuit 300 and sensor section 400. The electronics circuit 300 is described in more detail below with respect to FIG. 3. The sensor section 400 is described in more detail below with respect to FIG. 4.

The optical liquid detection system 200 can be used for detecting liquid intrusion and/or liquid leakage inside a battery pack 100 of an electrical vehicle, e.g., as shown in FIG. 1.

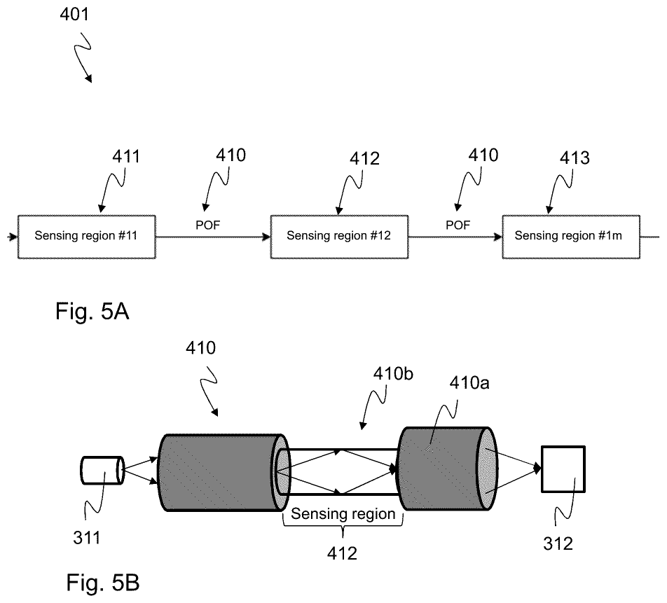

The optical liquid detection system 200 comprises at least one optical refractive index sensor 401, 402, 403. The at least one optical refractive index sensor 401, 402, 403, for example the first optical refractive index sensor 401 shown in FIG. 2, comprises a polymer optical fiber cable 410 as shown in FIGS. 4, 5A and 5B, for example. The polymer optical fiber cable 410 comprises an optical input 414, an optical output 415 and at least one optical sensing region 412 as detailed in FIGS. 4 and 5.

The optical liquid detection system 200 comprises at least one optical transmitter (TX1) 311 connected to the polymer optical fiber cable 410 of a respective optical refractive index sensor 401 for providing an optical signal 313 at the optical input 414 of the polymer optical fiber cable 410 or the POF sensor 401, respectively.

The optical refractive index sensor 401 is configured to output a response 314 of the optical signal 313 at the optical output 415 of the polymer optical fiber cable 410 based on a refraction index of a fluid covering at least partly the at least one optical sensing region 412, e.g., as shown in FIGS. 4, 5A and 5B. The response 314 is indicative of a liquid intrusion and/or liquid leakage inside the battery pack 100.

The fluid may correspond to the coolant which is designed for cooling the battery pack or the fluid may correspond to a mixture of the coolant with some other fluid such as water, e.g. in the case of a water intrusion fault or air, e.g. in the case of a coolant leakage. Of course, the fluid may also correspond to water, for example, in the case of a water intrusion fault or to air, for example, in the case of coolant leakage.

The optical liquid detection system 200 comprises at least one optical receiver (RX1) 312 connected to the polymer optical fiber cable 410 of the respective optical refractive index sensor 401 for receiving the response 314 of the optical signal 313 at the optical output 415 of the polymer optical fiber cable 410 or the POF sensor 401, respectively.

The at least one optical refractive index sensor 401 may be configured to output the response 314 of the optical signal 313 based on an evanescent wave absorption of the optical signal 313 in the at least one optical sensing region 412, e.g., as shown in more detail in FIGS. 5A and 5B.

The polymer optical fiber cable 410 of the at least one optical refractive index sensor 401 may comprise a fiber core 410b and a cladding 410a covering the fiber core 410b, as detailed in the example of FIGS. 5A and 5B. The cladding 410a may be at least partially removed in the at least one optical sensing region 412 as shown in FIGS. 5A and 5B.

The optical transmitter 311 may comprise an electrical-to-optical signal converter, e.g., a light emitting diode (LED), for providing the optical signal 313. The optical receiver 312 may comprise an optical-to-electrical signal converter 350, e.g., a photodiode, for converting the response 314 of the optical signal 313 into an electrical signal 351.

The optical liquid detection system 200 may comprise an electronics circuit 300, e.g., as shown in FIG. 3 in more detail. The electronics circuit 300 may be configured to provide an electrical current 341 to the optical transmitter 311 for generating the optical signal 313. The electronics circuit 300 may be further configured to process the electrical signal 351 corresponding to the response 314 of the optical signal 313.

The electronics circuit 300 may comprise a microcontroller 360 or microprocessor configured to determine a refractive index of the fluid based on the electrical signal 351.

The microcontroller 360 may be configured to determine a liquid intrusion and/or a liquid leakage inside the battery pack 100 based on the refractive index of the fluid.

The microcontroller 360 may be configured to monitor the refractive index of the fluid and to detect a liquid intrusion and/or a liquid leakage based on a deviation of the refractive index from a threshold.

This threshold may for example correspond to a refractive index of a coolant inside the battery pack 100. This refractive index may indicate a desired value for a battery pack 100 without any faults due to liquid leakage or intrusion.

The microcontroller 360 may be configured to monitor the refractive index of the fluid and to detect a liquid intrusion and/or a liquid leakage based on a predetermined model of the battery pack and/or a statistic characteristic of the refractive index.

The microcontroller 360 may be configured to detect a coolant leakage, a foreign liquid intrusion and/or a coolant ageing based on monitoring the refractive index over time.

The electronics circuit 300 may comprise a connector 315, e.g., as shown in FIG. 3, for mechanically and optically connecting the optical transmitter 311 and/or the optical receiver 312. The connector 315 may comprise a first plastic housing with an embedded light emitting diode and/or a second plastic housing with an embedded photodiode.

The connector 315 may be a single connector for connecting a single optical transmitter 311 and/or a single optical receiver 312 or it can be a multi-connector for connecting an optical transmitter 311 with the corresponding optical receiver 312 or for connecting multiple optical transmitters 311, 321, 331 and/or multiple corresponding optical receivers 312, 322, 332.

The at least one optical sensing region 412 may be placed at a top surface or a bottom surface inside a housing 180 (shown in FIG. 1) of the battery pack 100.

The optical liquid detection system 200 can be applied regardless of the energy-storage or the battery pack 100 cooling strategy. Whether it is cooled passively (radiators) or actively (cooling pipes) or even if the battery cells or modules are partially or fully immersed in coolant. The coolant or the cooling fluid, respectively, may be at least one of the following: synthetic oil, for example, poly-alpha-olefin (or poly-α-olefin, also abbreviated as PAO) oil, ethylene glycol and water, liquid dielectric cooling based on phase change, and the like.

The optical liquid detection system 200 can be applied for different battery cell chemistries, e.g., lithium-ion, lithium-polymer, etc. and their form factor, for example 18650 or 21700 lithium-ion cells, e.g., according to the IEC or ANSI C18 standards. The diagnostics can be performed using a model-based or a non-model based approach.

The optical liquid detection system 200 may be placed in a battery pack 100 as shown in FIG. 1. In one example, a battery pack 100 of an electrical vehicle comprises a housing 180 for housing at least one battery module 110, 120, 130 and a coolant, the at least one battery module 110, 120, 130 being immersed or submerged within the coolant. The battery pack 100 further comprises the optical liquid detection system 200 shown in FIG. 2 which can be mounted inside the housing 180, wherein the optical liquid detection system 200 is configured to detect foreign liquid intrusion, leakage of the coolant and/or ageing of the coolant.

FIG. 3 shows a block diagram of the electronics section or circuit 300 of the optical liquid detection system 200 shown in FIG. 2 according to one example.

FIGS. 3 and 4 illustrate a more detailed diagram of the optical liquid detection system 200 shown in FIG. 2. The optical liquid detection system 200 is divided into two main parts, the electrical circuit 300 shown in FIG. 3 and the optical sensors or sensor section 400 shown in FIG. 4.

The electronic circuit 300 shown in FIG. 3 can be a part of the BMS 140 shown in FIG. 1, or it can be a dedicated Electronic Control Unit (ECU).

The electronic circuit 300 shown in FIG. 3 comprises one or more connectors 315, 325, 335 for mechanically and optically connecting a respective optical transmitter 311, 321, 331 and/or the corresponding optical receiver 312, 322, 332. Each connector 315, 325, 335 may comprise a first plastic housing with an embedded light emitting diode and/or a second plastic housing with an embedded photodiode.

As described above with respect to FIG. 2, the connector 315 may be a single connector for connecting a single optical transmitter 311 and/or a single optical receiver 312 or it can be a multi-connector for connecting an optical transmitter 311 with the corresponding optical receiver 312 or for connecting multiple optical transmitters 311, 321, 331 and/or multiple corresponding optical receivers 312, 322, 332.

The electronic circuit 300 comprises current sources 340 to drive the polymer optical fiber transmitters 311, 321, 331. The electronic circuit 300 comprises photocurrent converters 350 to convert the returned light intensity, i.e., the response signal of the optical signal from the sensors, into electrical domain.

The optical transmitter 311 may comprise an electrical-to-optical signal converter, e.g., a light emitting diode (LED), for providing the optical signal 313. The optical receiver 312 may comprise an optical-to-electrical signal converter 350, e.g., a photodiode, for converting the response 314 of the optical signal 313 into an electrical signal 351.

The electronics circuit 300 may be configured to provide an electrical current 341, e.g., generated by the current sources 340, to the optical transmitter 311 for generating the optical signal 313.

The electronics circuit 300 may be further configured to process the electrical signal 351 corresponding to the response 314 of the optical signal 313 and/or corresponding to the response 324 of the optical signal 323 and/or corresponding to the response 334 of the optical signal 333. The responses 314, 324, 334 may be superimposed in the photocurrent converters 350 and may be converted to a single electrical signal 351 or to multiple electrical signals 351 (not shown in FIG. 3).

The electronics circuit 300 may comprise a microcontroller 360 or microprocessor configured to determine a refractive index of the fluid based on the electrical signal 351. This microcontroller 360 may be implemented in the BMS 140 shown in FIG. 1 or in a separate ECU.

The microcontroller 360 may be configured to determine a liquid intrusion and/or a liquid leakage inside the battery pack 100 based on the refractive index of the fluid.

The microcontroller 360 may be configured to monitor the refractive index of the fluid and to detect a liquid intrusion and/or a liquid leakage based on a deviation of the refractive index from a threshold. The threshold may for example correspond to a refractive index of a coolant inside the battery pack 100.

As described above with respect to FIG. 2, the microcontroller 360 may be configured to monitor the refractive index of the fluid and to detect a liquid intrusion and/or a liquid leakage based on a predetermined model of the battery pack and/or a statistic characteristic of the refractive index. The microcontroller 360 may be configured to detect a coolant leakage, a foreign liquid intrusion and/or a coolant ageing based on monitoring the refractive index over time.

FIG. 4 shows a block diagram of the sensor section 400 of the optical liquid detection system 200 shown in FIG. 2 according to one example.

The sensor section 400 comprises one or more optical refractive index sensors 401, 402, 403. An exemplary number of three sensors is shown in FIG. 4 but any integer number of sensors can be applied as well.

The at least one optical refractive index sensor 401, 402, 403 comprises a Polymer optical fiber cable 410, 420, 430 which comprises a respective optical input 414, 424, 434, a respective optical output 415, 425, 435 and at least one optical sensing region 411, 412, 413, 421, 422, 423, 431, 432, 433.

A respective optical signal 313, 323, 333 is received from a corresponding optical transmitter 311, 321, 331 of the electronics circuit 300, as shown in FIG. 3, at the respective optical input 414, 424, 434 of the polymer optical fiber cable 410, 420, 430 or the POF sensor 401, 402, 403 respectively.

The optical refractive index sensor 401, 402, 403 is configured to output a response 314, 324, 334 of the optical signal 313, 323, 333 at the optical output 415, 425, 435 of the polymer optical fiber cable 410, 420, 430 based on a refraction index of a fluid covering at least partly the at least one optical sensing region 411, 412, 413, 421, 422, 423, 431, 432, 433. The response 314, 324, 334 is indicative of a liquid intrusion and/or liquid leakage inside the battery pack 100.

FIGS. 5A and 5B show a schematic diagram illustrating an optical refractive index sensor 401 according to one example. The optical refractive index sensor 401 may correspond to the left-hand side optical refractive index sensor 401 in FIG. 4 having multiple sensing regions 411, 412, 413.

POF RI sensors, as exemplarily shown in FIGS. 5A and 5B, such as evanescent wave absorption POF sensors are sensors made out of polymer optical fiber cables in such way, that a portion of the POF cable or multiple portions of the POF cable are modified and exposed to contact with measurand (e.g., air, water, oil). These portions correspond to the sensing regions 412 of the POF sensor. The POF sensor can have one or more sensing regions, i.e. regions sensitive of refractive index.

In particular, the polymer optical fiber cable 410 of the optical refractive index sensor 401 shown in FIGS. 5A and 5B comprises a fiber core 410b and a cladding 410a covering the fiber core 410b. The cladding 410a is at least partially removed in the at least one optical sensing region 412 shown in FIGS. 5A and 5B.

The utilized refractive index sensor 401 shown in FIGS. 5A and 5B works in a way, so that the light is transmitted to the sensing region 412 via polymer optical fiber cables 410 over distances up to several meters. A small part of the optical fiber cable 410 is structurally modified by polishing or etching. By doing so, the light interacts with the surrounding medium (e.g., oil or air) and returns back to the driver. This can occur thanks to the evanescent wave absorption effect, which is used by the sensor 401. Returned light intensity can then be monitored by a microcontroller, e.g., the microcontroller 360 shown in FIG. 3.

RI allows to distinguish different types of fluids, such as air (RI=1.00 nD), water (RI=1.33 nD) or oil (RI=1.44 nD).

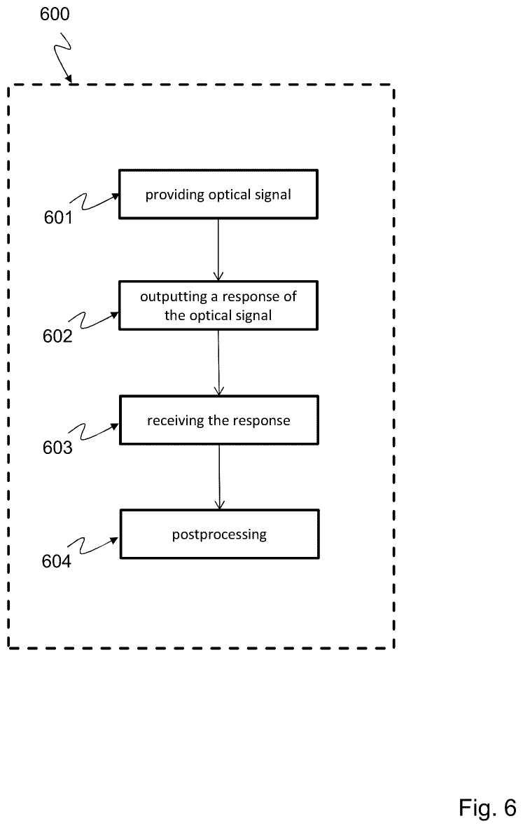

FIG. 6 shows a schematic diagram illustrating a method 600 for detecting liquid intrusion and/or liquid leakage inside a battery pack of an electrical vehicle according to the disclosure.

The method 600 can be used for detecting liquid intrusion and/or liquid leakage inside a battery pack 100 of an electrical vehicle, by at least one optical refractive index sensor 401 comprising a polymer optical fiber cable 410, the polymer optical fiber cable 410 comprising an optical input 414, an optical output 415 and at least one optical sensing region 412, e.g., as described above with respect to FIGS. 1 to 5B.

The method 600 comprises providing 601 an optical signal 313 at the optical input 414 of the polymer optical fiber cable 410, e.g., as described above with respect to FIGS. 1 to 5B.

The method 600 comprises outputting 602, by the at least one optical refractive index sensor 401, a response 314 of the optical signal 313 at the optical output 415 of the polymer optical fiber cable 410 based on a refraction index of a fluid covering at least partly the at least one optical sensing region 412, the response 314 being indicative of a liquid intrusion and/or liquid leakage inside the battery pack 100, e.g., as described above with respect to FIGS. 1 to 5B.

The method 600 comprises receiving 603 the response 314 of the optical signal 313 at the optical output 415 of the polymer optical fiber cable 410, e.g., as described above with respect to FIGS. 1 to 5B.

The method 600 may further comprise a postprocessing 604 of the response 314 of the optical signal 313.

The postprocessing 604 is for reducing false-alarms and diagnosis issues more robustly. For this purpose, the model-based or non-model-based diagnosis can take into account external factors such as operating temperature, ambient temperature, e.g., monitored by a microcontroller, as well in order to interpret the response in the current situation. By such postprocessing 604, effects such as a negative impact of temperature on electronics components can be compensated. For example, the operating temperature can significantly change LED's output luminous intensity which can be compensated by applying the postprocessing 604.

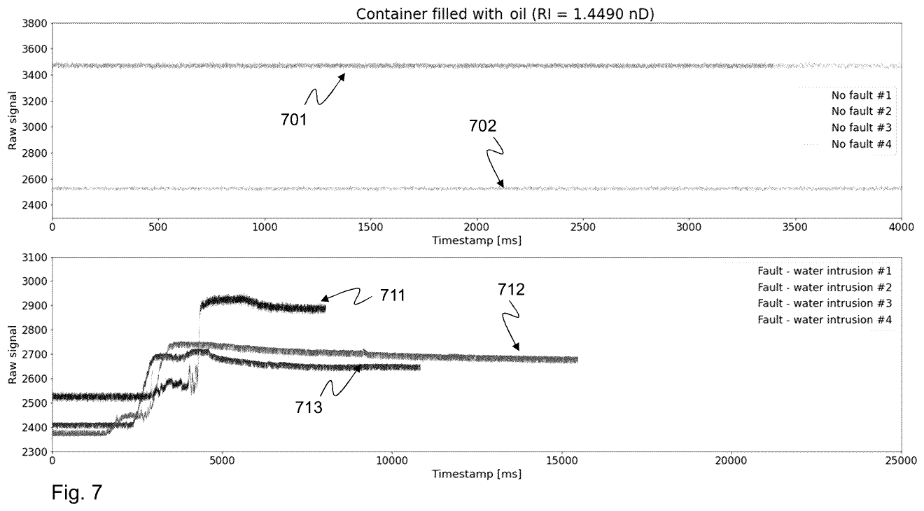

FIG. 7 shows an exemplary signal diagram illustrating a water intrusion fault detected by the optical liquid detection system 200 according to the disclosure.

The battery pack 100 or in the scenario presented in FIG. 7, the container with the sensor, was filled with mineral oil. After a short while, water was poured to simulate the water intrusion fault.

In the upper diagram, the curves 701 and 702 are straight lines with some noise, i.e., no fault is present.

In the bottom diagram, the curves 711, 712 and 713 show a deviation from their initial values after some time which indicates a water intrusion fault.

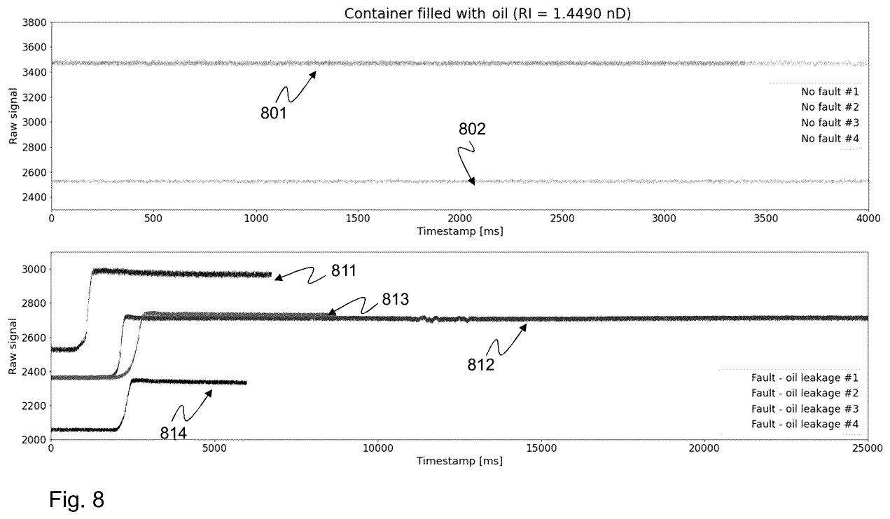

FIG. 8 shows an exemplary signal diagram illustrating an oil leakage fault detected by the optical liquid detection system 200 according to the disclosure.

The battery pack 100 or in the scenario presented in FIG. 8, the container with the sensor, was filled with mineral oil. After a short while, oil was removed to simulate the oil leakage fault.

In the upper diagram, the curves 801 and 802 are straight lines with some noise, i.e., no fault is present.

In the bottom diagram, the curves 811, 812, 813 and 814 show a deviation from their initial values after some time which indicates an oil leakage fault.

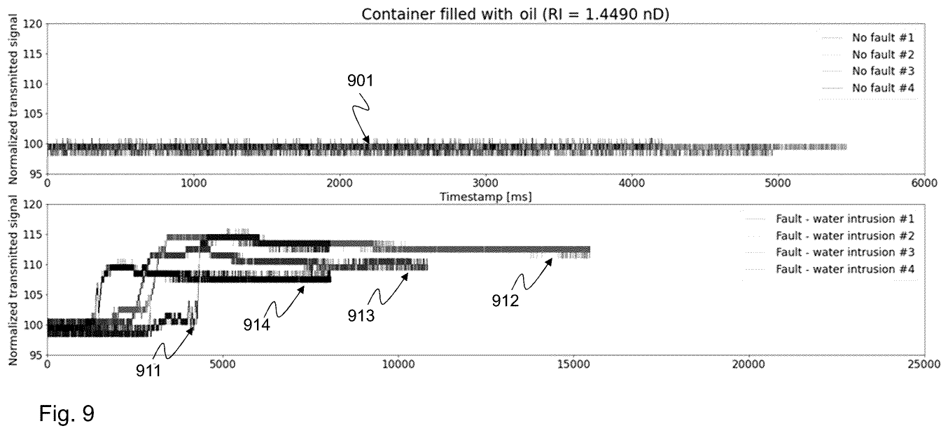

FIG. 9 shows an exemplary signal diagram in a normalized representation illustrating the water intrusion fault of FIG. 7.

For each battery pack, the optical liquid detection system is calibrated during faultless conditions to achieve measurement reference.

In the upper diagram, the curves 701 and 702 from FIG. 7 fall together due to the calibration to a single curve 901 that is a straight line with some noise, i.e., no fault is present.

In the bottom diagram, the curves 911, 912, 913 and 914 show a deflection from their initial values after some time which indicates a water intrusion fault.

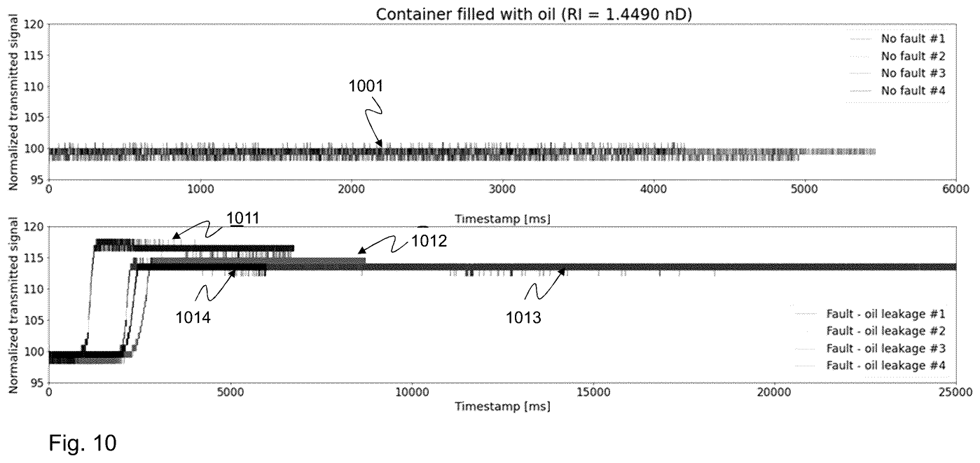

FIG. 10 shows an exemplary signal diagram in a normalized representation illustrating the oil leakage fault of FIG. 8.

For each battery pack, the optical liquid detection system is calibrated during faultless conditions to achieve measurement reference.

In the upper diagram, the curves 801 and 802 from FIG. 8 fall together due to the calibration to a single curve 1001 that is a straight line with some noise, i.e., no fault is present.

In the bottom diagram, the curves 1011, 1012, 1013 and 1014 show a deflection from their initial values after some time which indicates a water intrusion fault.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements may not be intended to be limited to being implemented in that particular sequence.

Many alternatives, modifications, and variations will be apparent to those skilled in the art in light of the above teachings. Of course, those skilled in the art readily recognize that there are numerous applications of the present disclosure beyond those described herein. While the present disclosure has been described with reference to one or more examples, those skilled in the art recognize that many changes may be made thereto without departing from the scope of the present disclosure. It is therefore to be understood that within the scope of the appended claims and their equivalents, the present disclosure may be practiced otherwise than as specifically described herein.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An optical liquid detection system for detecting at least one of a liquid intrusion and a liquid leakage inside a battery pack of an electrical vehicle, the optical liquid detection system comprising:
at least one optical refractive index sensor including a polymer optical fiber cable, the polymer optical fiber cable including an optical input, an optical output and at least one optical sensing region;
at least one optical transmitter connected to the polymer optical fiber cable of the at least one optical refractive index sensor, the at least one optical transmitter is configured to provide an optical signal at the optical input of the polymer optical fiber cable, the at least one optical refractive index sensor is configured to output a response of the optical signal at the optical output of the polymer optical fiber cable based on a refraction index of a fluid at least partly covering the at least one optical sensing region, the response being indicative of the at least one of the liquid intrusion and the liquid leakage inside the battery pack; and
at least one optical receiver connected to the polymer optical fiber cable of the at least one optical refractive index sensor configured to receive the response of the optical signal at the optical output of the polymer optical fiber cable.

2. The optical liquid detection system of claim 1,
wherein the response is indicative of a faultless condition in which there is no liquid intrusion or liquid leakage inside the battery pack.

3. The optical liquid detection system of claim 1,
wherein the at least one optical refractive index sensor is configured to output the response of the optical signal based on an evanescent wave absorption of the optical signal in the at least one optical sensing region.

4. The optical liquid detection system of claim 1,
wherein the polymer optical fiber cable of the at least one optical refractive index sensor comprises a fiber core and a cladding covering the fiber core, and the cladding is at least partially removed in the at least one optical sensing region.

5. The optical liquid detection system of claim 1,
wherein the at least one optical transmitter comprises an electrical-to-optical signal converter, configured to provide the optical signal, and the at least one optical receiver comprises an optical-to-electrical signal converter configured to convert the response of the optical signal into an electrical signal.

6. The optical liquid detection system of claim 5, wherein the electrical-to-optical signal converter is a light emitting diode, and the optical-to-electrical signal converter is a photodiode.

7. The optical liquid detection system of claim 5, further comprising an electronics circuit configured to:
provide an electrical current to the at least one optical transmitter to generate the optical signal; and
process the electrical signal corresponding to the response of the optical signal.

8. The optical liquid detection system of claim 7,
wherein the electronics circuit comprises a microcontroller configured to determine a refractive index of the fluid based on the electrical signal.

9. The optical liquid detection system of claim 8,
wherein the microcontroller is configured to determine the at least one of the liquid intrusion and the liquid leakage inside the battery pack based on the refractive index of the fluid.

10. The optical liquid detection system of claim 8,
wherein the microcontroller is configured to monitor the refractive index of the fluid and to detect the at least one of the liquid intrusion and the liquid leakage based on a deviation of the refractive index from a threshold.

11. The optical liquid detection system of claim 10,
wherein the threshold corresponds to a refractive index of a coolant inside the battery pack.

12. The optical liquid detection system of claim 8,
wherein the microcontroller is configured to monitor the refractive index of the fluid and to detect the at least one of the liquid intrusion and the liquid leakage based on at least one of a predetermined model of the battery pack and a statistic characteristic of the refractive index.

13. The optical liquid detection system of claim 8,
wherein the microcontroller is configured to detect at least one of a coolant leakage, a foreign liquid intrusion and a coolant ageing based on the refractive index over time.

14. The optical liquid detection system of claim 7, wherein the electronics circuit comprises:
a first connector configured to mechanically and optically connect the at least one optical transmitter, and a light emitting diode is embedded in the first connector; and
a second connector configured to mechanically and optically connect the at least one optical receiver, and a photodiode is embedded in the second connector.

15. The optical liquid detection system of claim 14,
wherein the first connector is embedded in a first plastic housing and the second connector is embedded in a second plastic housing.

16. The optical liquid detection system of claim 14, wherein the first connector and the second connector are embedded in a common plastic housing.

17. A battery pack of an electrical vehicle, the battery pack comprising:
a housing configured to house at least one battery module and a coolant, the at least one battery module immersed within the coolant; and
an optical liquid detection system according to claim 1 mounted inside the housing, wherein the optical liquid detection system is configured to detect at least one of foreign liquid intrusion, leakage of the coolant, and ageing of the coolant.

18. A method for detecting at least one of a liquid intrusion and a liquid leakage inside a battery pack of an electrical vehicle by at least one optical refractive index sensor comprising a polymer optical fiber cable, the polymer optical fiber cable including an optical input, an optical output and at least one optical sensing region, the method comprising:
providing an optical signal at the optical input of the polymer optical fiber cable;
outputting, by the at least one optical refractive index sensor, a response of the optical signal at the optical output of the polymer optical fiber cable based on a refraction index of a fluid covering at least partly the at least one optical sensing region, the response indicative of at least one of the liquid intrusion and the liquid leakage inside the battery pack; and
receiving the response of the optical signal at the optical output of the polymer optical fiber cable.

19. The method of claim 18, further comprising:
postprocessing the response of the optical signal based on at least one external factor.

20. The method of claim 19, wherein the at least one external factor includes an ambient temperature.
